(19) United States
(12) Patent Application Publication
(10) Pub. No.: US 2026/0127300 A1
(43) Pub. Date: May 7, 2026

(54) A METHOD FOR MANAGING COMMUNICATION WITH A PLURALITY OF ASSETS OF A RENEWABLE POWER PLANT

(71) Applicant: VESTAS WIND SYSTEMS A/S, Aarhus N (DK)

(72) Inventors: Anders REIMER, Hadsten (DK); Fabrice KRØYER-LOUDET, Beder (DK)

(21) Appl. No.: 19/481,426

(22) PCT Filed: Apr. 30, 2024
(86) PCT No.: PCT/DK2024/050098

§ 371 Date: Nov. 4, 2025

(30) Foreign Application Priority Data
May 4, 2023 (DK) PA202370220

(51) Int. Cl. G06F 21/60

(52) U.S. Cl. CPC G06F 21/606

(57) ABSTRACT

A method for managing communication of instructions to a plurality of controlled assets (4), eg. wind turbines, arranged within a private communication network of a renewable power plant (3) is disclosed. One or more requesting assets (5), arranged within the private communication network, contacts (6) a secure data centre (1) arranged externally with respect to the private communication network, on behalf of one or more controlled assets (4) being associated with that specific requesting asset (5). The secure data centre (1) generates a database (8) comprising a registry of controlled assets (4) for which instructions were requested, and representing a portfolio of controlled assets (4) being managed by the secure data centre (1). The secure data centre (1) subsequently manages communication of instructions originating from an external control centre (2) to each of the registered controlled assets (4) of the portfolio of the secure data centre (1), upon request from the requesting assets (5).

### FIELD OF THE INVENTION

The present invention relates to a method for managing communication of instructions to a plurality of controlled assets, such as wind turbines, forming part of a renewable power plant, and being arranged within a private communication network of the renewable power plant. The method according to the invention allows for safe as well as efficient communication of instructions to the assets.

### BACKGROUND OF THE INVENTION

Renewable power plants normally comprise a plurality of power generating assets, e.g. in the form of wind turbines, photovoltaic panels, etc., arranged within a specified geographical area. Power generated by the power generating assets will normally be supplied to an external power grid, preferably via a point of common coupling.

In addition to the power generating assets, a renewable power plant may comprise other kinds of assets, such as one or more central power plant controllers, one or more data collections systems, such as SCADA systems, one or more substations, etc. Such further assets may be required in order to appropriately control the power generating assets of the renewable power plant.

During operation of a renewable power plant, it may be required to provide various instructions to one or more of the assets of the renewable power plant. Such instructions could, e.g., include control instructions for the assets, e.g. in the form of new setpoints, stop or start commands, etc. Alternatively or additionally, the instructions could include software updates for the assets, and/or any other suitable kind of instructions.

Such instructions may sometimes originate from control centres or other similar entities, arranged remotely or externally with regard to the renewable power plant. It is therefore convenient if such external entities can communicate directly with the assets of the renewable power plant. However, due to cyber security threats, it is becoming increasingly common that direct external communication to assets of renewable power plants is not allowed. Instead, most of the assets may be allowed to communicate with each other only via a private communication network, and any communication to the private communication network may only be initiated by specified assets within the private communication network, not by external entities, and possibly only via a specifically trusted party outside the renewable power plant. Such a setup is sometimes referred to as an ‘iron dome’.

Though an ‘iron dome’ setup is safe with regard to cyber security, the process of providing the required instructions to the assets within the renewable power plant may be slow, inefficient and cumbersome.

### DESCRIPTION OF THE INVENTION

It is an object of embodiments of the invention to provide a method for managing communication of instructions to assets of a renewable power plant in a safe, reliable, easy and efficient manner.

The invention provides a method for managing communication of instructions to a plurality of controlled assets arranged within a private communication network of a renewable power plant, the method comprising the steps of:
one or more requesting assets, arranged within the private communication network, contacting a secure data centre arranged externally with respect to the private communication network, each requesting asset requesting instructions applying to one or more controlled assets being associated with that specific requesting asset,
in response to the received requests, the secure data centre registering each of the controlled assets being associated with the requesting assets and for which instructions were requested, and generating a database in the secure data centre, the database comprising a registry of the registered controlled assets, thereby building a portfolio of controlled assets being managed by the secure data centre, and
the secure data centre subsequently managing communication of instructions originating from an external control centre to each of the registered controlled assets of the portfolio of the secure data centre, upon request from the requesting assets.

Thus, the method according to the invention is a method for managing communication of instructions to a plurality of controlled assets arranged within a private communication network of a renewable power plant.

In the present context the term ‘renewable power plant’ should be interpreted to mean a plurality of renewable power generators, e.g. in the form of wind turbines, photovoltaic panels, etc., arranged within a specified geographical area, and which share some infrastructure, such as internal power grid, connection to an external power grid, substations, communication network, access roads, etc.

In the present context the term ‘controlled asset’ should be interpreted to mean an asset of the renewable power plant which may be in need for receiving instructions, e.g. in the form of control commands and/or software updates. The controlled asset may, e.g., be a renewable power generator, such as a wind turbine or a photovoltaic panel. Alternatively or additionally, the controlled asset may be a substation, a central power plant controller (PPC), or any other suitable kind of asset forming part of renewable power plant and which may need to receive instructions.

In the present context the term ‘private communication network’ should be interpreted to mean a communication network which allows the assets connected to the private communication network to communicate with each other, but which does not allow any external entities to connect to the private communication network. Accordingly, the private communication network establishes an ‘iron dome’ setup at the renewable power plant.

In the method according to the invention, one or more requesting assets initially contact a secure data centre arranged externally with respect to the private communication network. Similarly to the controlled assets, the requesting assets are also arranged within the private communication network, and thereby within the ‘iron dome’. When contacting the secure data centre, each requesting asset requests instructions which apply to one or more controlled assets being associated with that specific requesting asset.

In the present context the term ‘requesting asset’ should be interpreted to mean an asset of the renewable power plant which is able to contact the secure data centre in order to request instructions on behalf of one or more controlled assets of the renewable power plant, to the extent that such controlled assets are associated with the requesting asset performing a given request. For instance, a given requesting asset may also be a controlled asset, and in this case the requesting asset may request instructions applying to itself, in its capacity of being a controlled asset. Alternatively or additionally, a given requesting asset may be responsible for requesting instructions on behalf of one or more other (controlled) assets of the renewable power plant. In this case such other controlled assets are regarded as being associated with that requesting asset.

Accordingly, each of the requesting assets reach out, from a position within the private communication network, to the secure data centre, arranged externally with respect to the private communication network, in order to request instructions which apply to one or more controlled assets, possibly including itself, on behalf of which the requesting asset has been charged with the responsibility of obtaining relevant instructions.

In the present context the term ‘secure data centre’ should be interpreted to mean an entity which is arranged outside the private communication network, but which is still a trusted party in the sense that it is considered safe for the assets within the private communication network to communicate with the secure data centre, e.g. because it is under the control of an owner or manager of the renewable power plant. For instance, the secure data centre may be the only entity which the assets within the private communication network are allowed to contact. It is further noted that the contact to the secure data centre is initiated by assets within the private communication network, i.e. by the requesting assets. Accordingly, it is avoided that malicious or unauthorised parties, e.g. pretending to be the secure data centre, gain access to the private communication network.

In response to the received requests, the secure data centre registers each of the controlled assets being associated with the requesting assets and for which instructions were requested. Accordingly, all controlled assets on behalf of which instructions are requested, are registered by the secure data centre, regardless of whether the instructions were requested by the controlled assets themselves or by another requesting asset requesting instructions on their behalf.

Thus, a database is generated in the secure data centre, and the generated database comprises a registry of the registered controlled assets. Thereby a portfolio of controlled assets being managed by the secure data centre is built. Accordingly, once instructions have been requested for a given controlled asset, the secure data centre registers that this controlled asset is to be managed by the secure data centre, and that it should therefore form part of the portfolio defined by the database. Since this happens merely as a consequence of the requesting assets contacting the secure data centre and requesting relevant instructions, this is an easy manner for the secure data centre to keep track of which controlled assets it is supposed to manage.

Finally, the secure data centre subsequently manages communication of instructions originating from an external control centre to each of the registered controlled assets of the portfolio of the secure data centre, upon request from the requesting assets. In the present context the term ‘external control centre’ should be interpreted to mean a control centre which is arranged externally with respect to the private communication network. The external control centre may be considered a trusted party, similarly to the secure data centre. However, it is not ruled out that the external control centre is not considered a trusted party.

Furthermore, the external control centre may be the origin of various instructions which need to be communicated to the controlled assets within the private communication network. For instance, the external control centre may be a central control centre, possibly being responsible for instructions for a plurality of renewable power plants, and possibly being under the control of a manager, owner or manufacturer of the assets of the renewable power plants.

Accordingly, the secure data centre acts as a gatekeeper between the external control centre, where instructions for the controlled assets are generated, and the controlled assets within the private communication network, to which the instructions need to be communicated. Furthermore, since the communication of the instructions to the controlled assets is only performed upon request from the requesting assets, no malicious party will be able to access the private communication network, and it will not be possible to communicate unauthorised instructions, malware, etc., to the assets of the renewable power plant. On the other hand, the instructions which are actually required by the controlled assets are communicated safely and efficiently to the relevant controlled assets.

The step of the secure data centre managing communication of instructions may comprise the steps of:
the secure data centre requesting instructions related to all controlled assets in its portfolio from the external control centre,
the external control centre making the requested instructions available, and the secure data centre retrieving the requested instructions from the external control centre,
the secure data centre storing the retrieved instructions in a storage device at the secure data centre, and
each requesting asset retrieving instructions being relevant to one or more controlled assets being associated with that requesting asset from the storage device.

According to this embodiment, the secure data centre initially contacts the external control centre in order to request that any instruction which is relevant to any of the controlled assets in its portfolio is made available. Due to the portfolio and the corresponding database which was built in the manner described above, it is efficiently ensured that secure data centre requests instructions being relevant to each of the controlled assets which it is supposed to manage, while efficiently ensuring that it does not request instructions being relevant to controlled assets which it is not supposed to manage.

In response to the request, the external control centre makes the requested instructions available, and the secure data centre retrieves the requested instructions from the external control centre. Thus, any communication of the instructions from the external control centre to the secure data centre is initiated and controlled by the secure data centre, i.e. the external control centre is not allowed to actively push the instructions towards the secure data centre, and the secure data centre instead must pull the instructions from the external control centre. This ensures a high security level.

The secure data centre then stores the retrieved instructions in a storage device at the secure data centre, and finally each requesting asset retrieves instructions being relevant to one or more controlled assets being associated with that requesting asset from the storage device. Thus, the communication of instructions from the secure data centre to the requesting assets, and further on to the relevant controlled assets, is initiated and controlled by the respective requesting assets, and thereby from within the private communication network, i.e. as a ‘pull’ operation, rather than as a ‘push’ operation.

Accordingly, in each communication step, the request for instructions originates from the receiving party, the requested instructions are made available by the providing party, and the receiving party actively retrieves the instructions which were made available. This results in a high security level where the risk of unauthorised and/or malicious parties accessing the private communication network and/or that unauthorised instructions or malware is delivered to the controlled assets is minimised.

The step of each requesting asset retrieving instructions may be performed independently of the step of the secure data centre requesting instructions from the external control centre.

According to this embodiment, once a given controlled asset has been registered in the database at the secure data centre, and thereby defined as forming part of the portfolio of the secure data centre, the secure data centre may request and retrieve instructions being relevant for that controlled asset from the external control centre independently of when the requesting assets request and retrieve instructions from the secure data centre. Thus, when the requesting assets contact the secure data centre and request relevant instructions, these instructions may already have been retrieved from the external control centre by the secure data centre and stored in the storage device. Accordingly, the relevant instructions can be immediately retrieved by the requesting assets and provided to the relevant controlled assets. This reduces delays and latency times in the communication process, thereby ensuring that relevant instructions are provided fast and reliably to the controlled assets.

The embodiment described above may be referred to as an asynchronous approach. As an alternative, a synchronous approach may be applied, in which the secure data centre only contacts the external control centre when a request for instructions is received from a requesting asset. In this case the requesting asset needs to await that the secure data centre requests instructions from the external control centre, that the external control centre makes the requested instructions available to the secure data centre, and that the secure data centre retrieves the instructions, before the requesting asset is able to retrieve the instructions from the storage device at the secure data centre. This introduces delays and latency in the communication process, as compared to the asynchronous approach. However, the synchronous approach is still within the scope of the present invention.

According to one embodiment, the secure data centre may request instructions being relevant for a given controlled asset only once, and the external control centre may subsequently make all new instructions related to that controlled asset available to the secure data centre, via a secure communication channel.

According to this embodiment, once the secure data centre has informed the external control centre that a given controlled asset forms part of its portfolio, it will not be necessary that the secure data centre specifically requests instructions being relevant for that controlled asset at a later point in time. Instead, this information is noted by the external control centre, and whenever new instructions are generated which are relevant for the controlled asset, such instructions are automatically made available to the secure data centre. The secure data centre may then retrieve such instructions, via the secure communication channel, and store them in the storage device, whenever it is convenient or appropriate.

According to an alternative embodiment, the external control centre may make instructions available to the secure data centre only upon request from the secure data centre. According to this embodiment, the secure data centre needs to specifically request instructions for the controlled assets of its portfolio each time it wants to retrieve such instructions and store them in the storage device. This reduces the risk of a malicious or unauthorised party eavesdropping or retrieving the instructions.

The secure data centre may, e.g., request instructions from the external control centre at regular time intervals and/or whenever communication and/or processing loads are low.

The method may further comprise the step of authorizing the instructions retrieved from the external control centre at the secure data centre before making the instructions available to the requesting assets.

According to this embodiment, when the secure data centre has retrieved instructions from the external control centre, an authorization process is performed in order to ensure that the retrieved instructions are genuine and relevant to the controlled assets within the portfolio of the secure data centre. Since this is done prior to making the instructions available to the requesting assets, and therefore before the requesting assets are allowed to retrieve the instructions and provide them to the controlled assets, this reduces the risk of unauthorised instructions or malware entering the private communication network and reaching the controlled assets.

The authorization process may be performed either before or after the instructions are stored in the storage device at the secure data centre.

The method may further comprise the step of the external control centre validating requests from the secure data centre before making the requested instructions available to the secure data centre.

According to this embodiment, upon receipt of a request for instructions from the secure data centre, the external control centre performs a validation process in order to ensure that the received request is valid and genuine. This could, e.g., include ensuring that the requesting secure data centre is in fact authorised to request the instructions on behalf of the relevant controlled assets. Thus, the requested instructions are only made available to the secure data centre if the validation process reveals that the request for instructions is valid. This reduces the risk of unauthorised parties gaining access to the instructions.

The method may further comprise the steps of:
an additional requesting asset of the renewable power plant contacting the secure data centre and requesting instructions applying to one or more controlled assets being associated with the additional requesting asset, and
in response to the request, the secure data centre registering each of the one or more controlled assets being associated with the additional requesting asset and for which instructions were requested, and adding the registered controlled asset(s) of the additional requesting asset to the database in the secure data centre, thereby adding the additional controlled asset(s) to the portfolio of controlled assets being managed by the secure data centre.

According to this embodiment, the database which defines the portfolio of controlled assets being managed by the secure data centre is continuously updated by adding new controlled assets for which instructions are requested. This is done essentially by repeating the steps described above, upon receipt of a request for instructions related to one or more controlled assets which were not previously included in the portfolio. Thus, it is ensured that the portfolio of managed controlled assets is always up to date, in the sense that it includes all controlled assets which the secure data centre is supposed to manage. Furthermore, this is obtained without requiring any active steps from the secure data centre, and therefore in an easy and reliable manner.

At least one of the requesting assets may also be a controlled asset. According to this embodiment, for at least one of the controlled assets of the renewable power plant, the asset which contacts the secure data centre in order to request instructions, and which may subsequently retrieve instructions made available at the secure data centre, is the controlled asset itself. In this case the controlled asset (which is also a requesting asset) may request instructions being relevant to itself only. However, it is not ruled out that a controlled asset requests instructions on behalf of one or more further controlled assets, in addition to requesting instructions being relevant to itself. In this case the controlled asset acts as a requesting asset for these additional controlled assets.

Alternatively or additionally, at least one of the requesting assets may be associated with at least two controlled assets, and the at least one requesting asset may request instructions on behalf of the at least two controlled assets being associated therewith.

According to this embodiment, at least one of the requesting assets need not necessarily be a controlled asset itself, but is merely granted the responsibility for obtaining instructions for two or more controlled assets being associated therewith. However, it is not ruled out that one of the controlled assets being associated with the requesting asset is in fact the requesting asset itself.

At least some of the controlled assets may be wind turbines. Alternatively or additionally, the controlled assets may include other kinds of power producing assets of the renewable power plant, such as photovoltaic panels. Alternatively or additionally, the controlled assets may include assets which are not power producing, but which may be in need for control instructions, software updates, etc. Such assets include, but are not limited to, central power plant controllers (PPC), SCADA systems, substations, etc.

At least some of the requesting assets may be central controllers or servers arranged to communicate with two or more wind turbines of the renewable power plant via the private communication network. Such requesting assets may advantageously be able to request instructions on behalf of a plurality of controlled assets, e.g. in the form of wind turbines. The central controllers or servers could, e.g., be in the form of power plant controllers (PPC), SCADA systems, etc., or it could be the wind turbines themselves requesting instructions.

### BRIEF DESCRIPTION OF THE DRAWING

The invention will now be described in further detail with reference to the accompanying drawing in which

FIG. 1 is a schematic view of a system performing a method according to an embodiment of the invention.

### DETAILED DESCRIPTION OF THE DRAWING

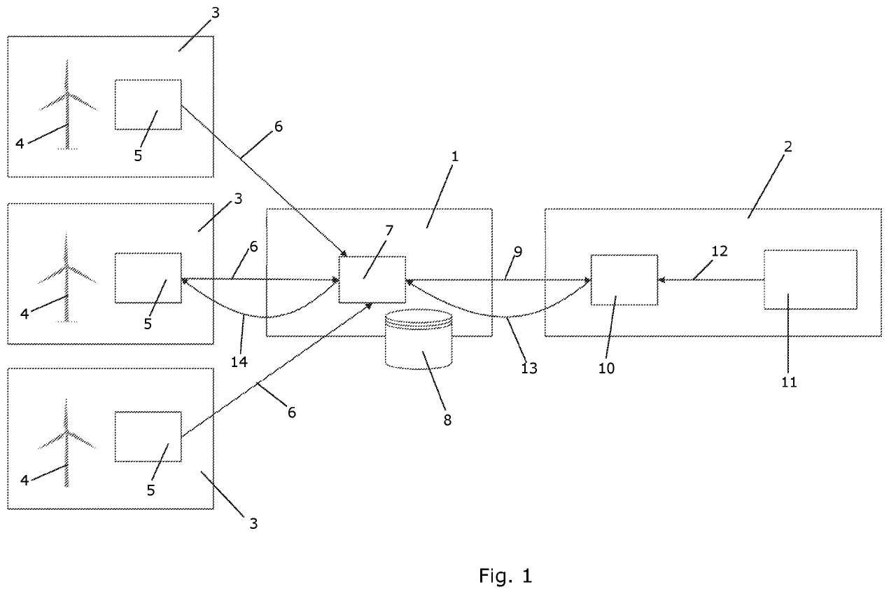

FIG. 1 shows a secure data centre 1, an external control centre 2 and a number of renewable power plants 3, three of which are shown. Each of the renewable power plants 3 comprises a number of controlled assets 4, represented by wind turbines, and a number of requesting assets 5. In FIG. 1, one controlled asset 4 and one requesting asset 5 are shown for each renewable power plant 3. However, it should be understood that each renewable power plant 3 may comprise a plurality of controlled assets 4 and/or a plurality of requesting assets 5.

The assets 4, 5 of a given renewable power plant 3 are arranged within a private communication network. Accordingly, the assets 4, 5 may be allowed to communicate with each other, via the private communication network, but communication to and from the private communication network is restricted.

When performing a method according to an embodiment of the invention, the requesting assets 5 of the renewable power plants 3 contact 6 a request relay service 7 at the secure data centre 1. Each of the requesting assets 5 requests instructions being relevant to one or more controlled assets 4 being associated with the requesting asset 5.

The secure data centre 1 is arranged outside the respective private communication networks of the renewable power plants 3. Accordingly, the requesting assets 5 contacting 6 the relay service 7 of the secure data centre 1 constitutes communication from within the respective private communication networks to an entity arranged outside the private communication networks. However, since this communication 6 is initiated by entities arranged within the respective private communication networks, the risk of unauthorised access to the private communication network, and to the controlled assets 4 and requesting assets 5 arranged therein, is minimised.

Furthermore, the secure data centre 1 may preferably be a trusted party, in the sense that the requesting assets 5 are allowed to contact the secure data centre 1, even though it is arranged outside the private communication network. The secure data centre 1 may even be the only entity outside the private communication network which the requesting assets 5 are allowed to contact.

At least one of the requesting assets 5 may also be a controlled asset 4. In this case the requesting asset 5 may request instructions being relevant to itself only. Alternatively, the requesting asset 5 may request instructions being relevant to one or more other controlled assets 4 being associated with the requesting asset 5, in addition to requesting instructions being relevant to itself.

Alternatively or additionally, at least one of the requesting assets 5 may be of a kind which is not a controlled asset, i.e. which does not in itself require instructions, such as control commands, software updates, etc. In this case the requesting asset 5 is merely requesting instructions on behalf of one or more controlled assets 4 being associated with the requesting asset 5, in the sense that the requesting asset 5 has been charged with the responsibility for obtaining instructions for and on behalf of these controlled assets 4.

Upon receipt of the requests, the secure data centre 1 registers each of the controlled assets 4 for which instructions are being requested by the requesting assets 5, and generates a database 8. The database 8 comprises a registry of the registered controlled assets 4 and defines a portfolio of controlled assets 4 which are to be managed by the secure data centre 1. Thus, the database 8, and thereby the portfolio of controlled assets 4, is generated merely as a consequence of the requesting assets 5 contacting 6 the relay service 7 of the secure data centre 1 and requesting instructions on behalf of the controlled assets 4. Accordingly, this is easy and reliable, and does not require active steps of the secure data centre 1.

The relay service 7 of the secure data centre 1 then contacts 9 a relay service 10 at the external control centre 2 and requests instructions related to each of the controlled assets 4 of its portfolio. A central application 11 of the external control centre 2 then makes the requested instructions available 12 to the secure data centre 1, possibly subject to an authorization process. The external control centre 2 is typically not regarded as a trusted party, and the requesting assets 5 are therefore not allowed to contact the external control centre 2 directly. Accordingly, it is an advantage that the contact 9 to the external control centre 2 is initiated by the secure data centre 1.

The secure data centre 1 then retrieves 13 the instructions which were made available at the external data centre 2, and stores these in a storage device at the secure data centre 1. Subsequently, the requesting assets 5 retrieve 14 the relevant instructions from the storage device at the secure data centre 1, and distribute the retrieved instructions to the relevant controlled assets 4.

In FIG. 1 it is only illustrated that the requesting asset 5 of one of the renewable power plants 3 retrieves 14 instructions from the secure data centre 1. However, it should be understood that the requesting assets 5 of the other renewable power plants 3 will also retrieve relevant instructions from the secure data centre 1. It is further noted that the requesting assets 5 may retrieve 14 instructions from the secure data centre 1 independently of each other.

Thus, all communication of instructions in a direction from the external control centre 2 towards the assets 4, 5 within the private communication networks is performed by a receiving party (the secure data centre 2 and the requesting assets 5, respectively) which retrieves the instructions from a providing party (the external control centre 2 and the secure data centre 1, respectively). This significantly reduces the risk of unauthorised instructions and/or malware reaching the assets 4, 5 within the private communication networks of the renewable power plants 3.

Furthermore, the retrieval 13 of instructions from the external control centre 2 to the secure data centre 2 and the retrieval 14 of instructions from the secure data centre 1 to the requesting assets 5 are performed independently of each other. Thus, when the requesting assets 5 contact the secure data centre 1 in order to retrieve 14 relevant instructions, these instructions are already available in the storage device of the secure data centre 2, and can therefore be retrieved 14 immediately by the requesting assets 5. Accordingly, the process may be regarded as an asynchronous process. This reduces delays and latency times in the system.

1. A method for managing communication of instructions to a plurality of controlled assets arranged within a private communication network of a renewable power plant, the method comprising the steps of:
one or more requesting assets, arranged within the private communication network, contacting a secure data centre arranged externally with respect to the private communication network, each requesting asset requesting instructions applying to one or more controlled assets being associated with that specific requesting asset,
in response to the received requests, the secure data centre registering each of the controlled assets being associated with the requesting assets and for which instructions were requested, and generating a database in the secure data centre, the database comprising a registry of the registered controlled assets, thereby building a portfolio of controlled assets being managed by the secure data centre, and
the secure data centre subsequently managing communication of instructions originating from an external control centre to each of the registered controlled assets of the portfolio of the secure data centre, upon request from the requesting assets.

2. A method according to claim 1, wherein the step of the secure data centre managing communication instructions comprises the steps of:
the secure data centre requesting instructions related to all controlled assets in its portfolio from the external control centre,
the external control centre making the requested instructions available, and the secure data centre retrieving the requested instructions from the external control centre,
the secure data centre storing the retrieved instructions in a storage device at the secure data centre, and
each requesting asset retrieving instructions being relevant to one or more controlled assets being associated with that requesting asset from the storage device.

3. A method according to claim 2, wherein the step of each requesting asset retrieving instructions is performed independently of the step of the secure data centre requesting instructions from the external control centre.

4. A method according to claim 2, wherein the secure data centre requests instructions being relevant for a given controlled asset only once, and wherein the external control centre subsequently makes all new instructions related to that controlled asset available to the secure data centre, via a secure communication channel.

5. A method according to claim 2, wherein the external control centre makes instructions available to the secure data centre only upon request from the secure data centre.

6. A method according to claim 2, further comprising the step of authorizing the instructions retrieved from the external control centre at the secure data centre before making the instructions available to the requesting assets.

7. A method according to claim 2, further comprising the step of the external control centre validating requests from the secure data centre before making the requested instructions available to the secure data centre.

8. A method according to claim 2, further comprising the steps of:
an additional requesting asset of the renewable power plant contacting the secure data centre and requesting instructions applying to one or more controlled assets being associated with the additional requesting asset, and
in response to the request, the secure data centre registering each of the one or more controlled assets being associated with the additional requesting asset and for which instructions were requested, and adding the registered controlled asset(s) of the additional requesting asset to the database in the secure data centre, thereby adding the additional controlled asset(s) to the portfolio of controlled assets being managed by the secure data centre.

9. A method according to claim 2, wherein at least one of the requesting assets is also a controlled asset.

10. A method according to claim 2, wherein at least one of the requesting assets is associated with at least two controlled assets, and wherein the at least one requesting asset requests instructions on behalf of the at least two controlled assets being associated therewith.

11. A method according to claim 2, wherein at least some of the controlled assets are wind turbines.

12. A method according to claim 2, wherein at least some of the requesting assets are central controllers or servers arranged to communicate with two or more wind turbines of the renewable power plant via the private communication network.
